(19) United States
(12) Patent Application Publication
(10) Pub. No.: US 2006/0178928 A1
(43) Pub. Date: Aug. 10, 2006

(54) Innovation capture system

(75) Inventors: Kevin F. Carney, Plymouth, MA (US); John M. Mullaly, Rye Brook, NY (US); Brad A. Sperbeck, New Rochelle, NY (US)

Correspondence Address: Steven Fischman, Esq.;Scully, Scott, Murphy & Presser, 400 Garden City Plaza, Garden City, NY, 11530, US

(73) Assignee: International Business Machines Corporation, Armonk, NY (US)

(21) Appl. No.: 11/055,521

(22) Filed: Feb. 10, 2005

(51) Int. Cl. G06F 17/30

(52) U.S. Cl. 705/10

(57) ABSTRACT

Disclosed are a method, system and computer software tool for capturing innovation. The software tool comprises means for entering an innovation into a database, and a system for evaluating said innovation. The software tool further comprises means for completing a business plan for implementing said innovation, and means for mapping said innovation to specific customer pain points. The preferred embodiment of the invention allows for a highly efficient tracking and management of innovation ideas. It does this by using a number of features. including workflow functionality to efficiently process, manage, and evaluate innovation ideas. The preferred embodiment also allows for innovation ideas to be managed in a lifecycle model, with different requirements by lifecycle stage.

### Background Of The Invention

1. Field of the Invention

This invention generally relates to an innovation capture system; and, more specifically, the invention relates to a method, system and software tool that enables tracking, evaluation and management of potential opportunities for innovation.

2. Background Art

Companies need to innovate to achieve competitive advantage and enable revenue and profit growth. In a recent survey, more than 50% of respondents said innovation is one of the five most important factors in building competitive advantage, and more than 10% said it is the single most important factor.

However, an inhibitor to successful innovation is the fact that companies do not have efficient systems to track, evaluate, and manage all of the different potential sources of innovation that exist within the enterprise.

There are some known systems for managing ideas or innovation; however, none of these existing systems is believed to provide a complete solution. For the most part, known systems store and display information, but do not have workflow functionality (to process, evaluate and manage opportunities) or ability to report data and measure against portfolio targets.

For example, known systems include databases used within an enterprise that capture business plans or idea submissions, and record information about their status. These databases may capture information about an opportunity; however, they may not provide important, additional functionality essential to managing innovation ideas including evaluation of opportunities, workflow to manage the evaluation, and the ability to set portfolio targets for the innovation ideas and measure attainment of targets.

Other known systems include databases accessible to the public that provide information about (or for SW, downloads of) innovations. These databases normally allow a search by topic and then provide information about a given innovation. Some examples include: IBM's alphaworks website, which provides access to IBM's emerging SW technologies currently under development; and Delphion Research, which contains a database of worldwide patents, both granted and applied, and allows for searching of the patent database. These types of databases, while very useful for certain purposes, do not provide the workflow or reporting functionality that may be desired in a more complete system for tracking, evaluating and managing innovation ideas.

### SUMMARY OF THE INVENTION

An object of this invention is to provide an innovation capture system that enables tracking, evaluation, and management of potential opportunities for innovation.

Another object of the invention is to provide an improved innovation capture system that allows innovation ideas to be managed as a portfolio by assigning growth opportunities to different lifecycle changes.

These and other objectives are attained with a method, system and computer software tool for capturing innovation. The software tool comprises means for entering an innovation into a database, and a system for evaluating said innovation. The software tool further comprises means for completing a business plan for implementing said innovation, and means for mapping said innovation to specific customer pain points.

The preferred embodiment of the invention, described below in detail, allows for a highly efficient tracking and management of innovation ideas. It does this by using a number of features. More specifically, this preferred embodiment has workflow functionality to efficiently process, manage, and evaluate innovation ideas. The preferred embodiment also allows for innovation ideas to be managed in a lifecycle model, with different requirements by lifecycle stage, and has different views so that users can see the types of innovation ideas most relevant to them. Further, preferably, the invention stores innovation ideas so that they can be recalled and acted on as different circumstances change their importance or status, and enables report generation and tracking against portfolio targets.

In addition, the preferred embodiment of the invention supports four important attributes: Responsiveness, Variability, Focus and Resilience. The preferred embodiment of the invention provides responsiveness in that it provides a faster response to meet customer needs through tracking and management of new sources of innovation that can be rapidly applied as customer needs and market trends evolve. Improved variability is provided in that the invention provides the ability to flexibly plug in single innovation ideas or combinations as customer needs or emerging trends dictate. Ideas that are not immediately acted on/invested in can be recalled on demand.

A high degree of focus is achieved because the invention enhances the ability of an enterprise to focus on innovation, which may be a primary core competency of the enterprise. Also, significant resilience is provided in that innovation from many sources is managed, backed up, and protected in one central repository, versus in dozens of repositories or in collective uncodified knowledge.

Further benefits and advantages of the invention will become apparent from a consideration of the following detailed description, given with reference to the accompanying drawings, which specify and show preferred embodiments of the invention.

### BRIEF DESCRIPTION OF THE DRAWINGS

FIG. 1 schematically illustrates a software tool for implementing this invention.

FIG. 2 shows an idea submission form that may be used in the present invention.

FIG. 3 illustrates a computer screen that shows a status change workflow option.

FIG. 4 shows a computer screen illustrating a lifecycle change workflow option.

FIG. 5 shows an evaluation form that may be used in the practice of this invention.

FIG. 6 shows a compute screen that may be used to group opportunities for viewing.

### DETAILED DESCRIPTION OF THE PREFERRED EMBODIMENTS

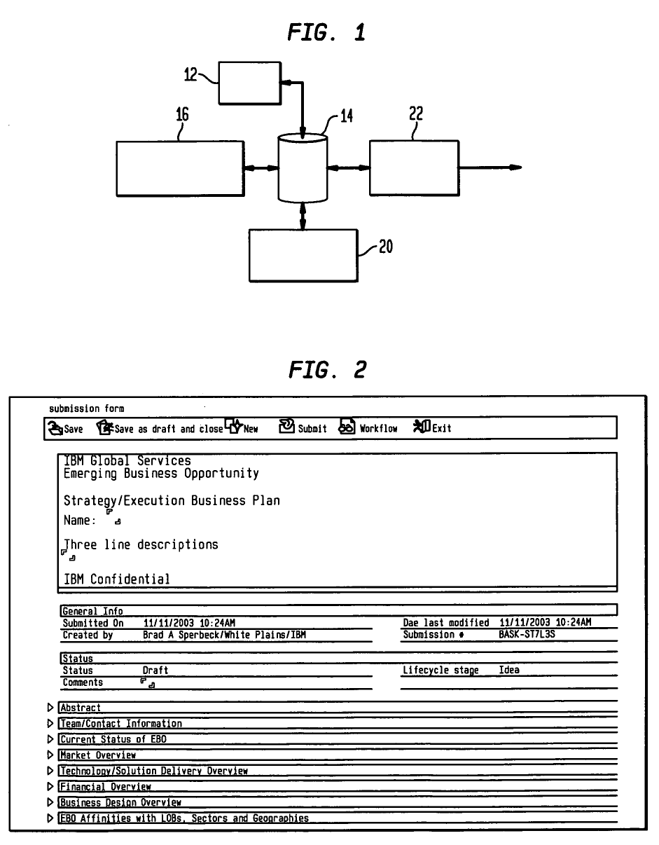

The present invention provides a method, system and software tool that enables tracking, evaluation and management of potential opportunities for innovation. FIG. 1 schematically illustrates a tool 10 embodying this invention. Tool 10 comprises means 12 for entering an innovation into a database 14, and a system 16 for evaluating said innovation. Tool 10 further comprises means 20 for completing a business plan for implementing said innovation, and means 22 for mapping said innovation to specific customer pain points.

With the preferred embodiment of the invention, new innovation ideas are entered in the system by submitters. Anyone in the enterprise can enter an idea but only team members on the access list can view and evaluate the ideas that are entered. The submission form contains various text and data fields, most of them are optional when an idea is first entered into the database but a few key fields are required. The submitter is able to save drafts, when ready they “submit” the idea for evaluation and receive an automated note thanking them for their submission and notifying them of the person responsible for the evaluation process. FIG. 2 is a picture (partial view) of the submission form that may be used in the innovation capture system of this invention.

Once an idea is entered, an automated email message is sent to the “queue manager” (the person who is managing the database). The queue manager clicks on a link in the email message to access the new idea in the database (or alternatively, the queue manager could manually find the new idea in the database). Depending on the completeness of the submission and the potential attractiveness of the opportunity, the submitter may: send an automated request for other team members to evaluate the opportunity; evaluate the opportunity without feedback from the other team members; or change the “Lifecycle Stage” or “Status” of the opportunity.

The “Status” refers to the state of the opportunity in the review process. The “Lifecycle Stage” allows for ideas to pass the first stage of development and be managed according to their lifecycle stage. For example, the working model has “Ideas” as the first stage, “Candidates” as the second stage, and “Pre-EBOs” as the third stage. Requirements differ and become increasingly rigorous by lifecycle stage. For example, in the working model “Ideas,” the submitter must enter a few basic fields of information and provide background information, and in the next stage “Candidates,” the submitter must complete a business plan that is approved by an evaluation committee.

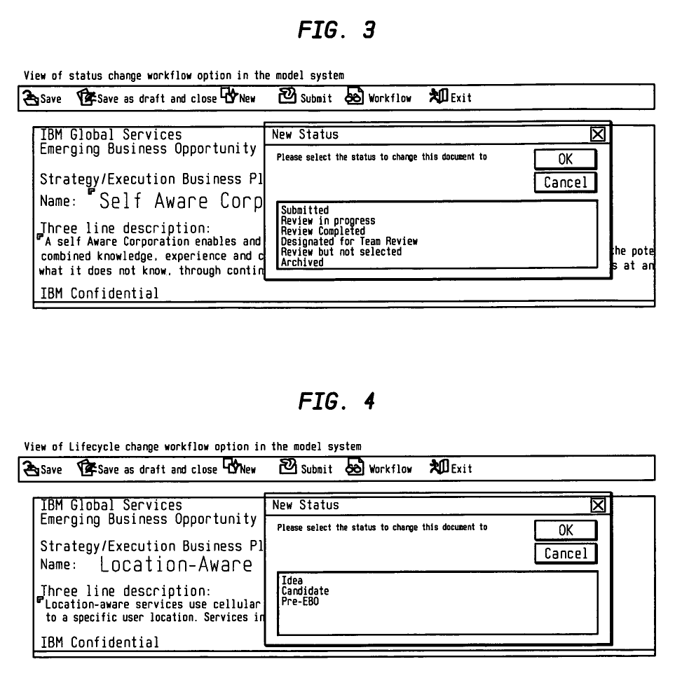

FIG. 3 shows a computer screen that illustrates the Status change workflow option, and FIG. 4 shows a computer screen that shows the Lifecycle change workflow option.

Team members evaluate the growth opportunities in the system, either ad hoc or in response to a request from the queue manger. Evaluations are visible to all team members but not to the submitter of the proposal. There is one master form for the evaluation that is controlled by the queue manager. For example, five team members can submit evaluations simultaneously, they will all be visible, and the queue manager can then view all of the evaluations and submit an evaluation on the master form. The queue manager is automatically notified when an evaluation is submitted.

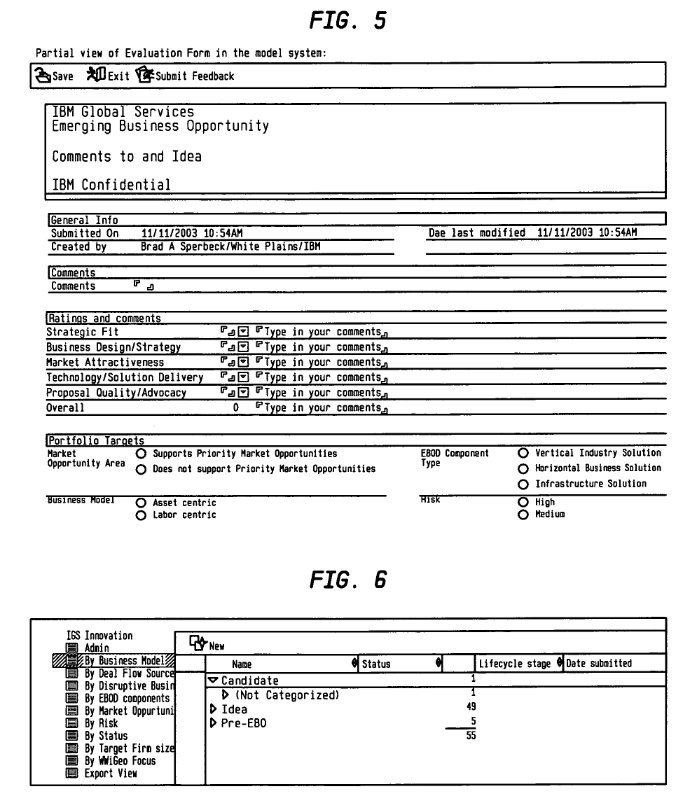

FIG. 5 is a partial view of an evaluation form that may be used in the invention.

Opportunities can be seen in various views so that team members can look for certain types of opportunities or look at groupings that are most relevant to them. For example, there could be a view by Geography so that team members in the Americas, Asia Pacific, and Europe could see any opportunities specific to their geography. FIG. 7 shows a computer screen that may be used to group the opportunities.

The present invention provides a number of important advantages. For instance, the invention provides the ability to manage the innovations through different lifecycle stages, including project management/status reporting (i.e., managing the projects and developing them as new businesses through the database). The invention also provides an ability for a sales force to access innovation from the database and apply it directly to their accounts.

This is made possible by incorporating basic information/description of the innovation, IP/presentations, and mapping of the innovation to specific customer pain points, which are built into the database (the database can be segmented differently for different companies). Thus, a sales person in a particular industry can see which innovations are available that they can bring forward to solve a customer's specific pain point.

In addition, the preferred embodiment of the invention provides linkage as one aspect of a broader and more comprehensive innovation management system. The innovation management system is a comprehensive system for managing innovation including, for example, management of a network of innovation contacts, innovative customer engagement management and tracking, management of market development programs. Also, the present invention incorporates leading edge thinking on innovation/new product and service development into the database design. Preferably, the database contains features for screening and management such as opportunity attractiveness and commercialization readiness.

As will be readily apparent to those skilled in the art, the present invention can be realized in hardware, software, or a combination of hardware and software. Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized.

The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention.

What is claimed is:

1. An innovation tool, comprising:
means for entering an innovation into a database;
a system for evaluating said innovation;
means for completing a business plan for implementing said innovation; and
means for mapping said innovation to specific customer pain points.

2. An innovation tool according to claim 1, wherein said customer pain points are built into said database.

3. An innovation tool according to claim 1, further comprising:
means to identify said specific customer pain points; and
means, acting in response to one of said customer pain points being identified, to display said innovation.

4. An innovation tool according to claim 1, wherein:
said system for evaluating said innovation includes means to pass said innovation through a plurality of stages of development, each of said stages having a set of requirements for said innovation;
said stages are arranged in an order; and
the requirements for said stages become increasingly rigorous in said order.

5. An innovation tool according to claim 1, wherein said system for evaluating said innovation includes:
means to identify a queue manager for managing said database; and
means to inform said queue manager when said innovation is entered into said database.

6. An innovation tool according to claim 5, wherein said system for evaluating further includes:
means to identify a group of people to evaluate said innovation;
means, for each of said group of people, to provide an evaluation of said innovation;
means to notify said queue manger whenever one of said evaluations is provided; and
means to enable said queue manager to see said evaluations from said group of people.

7. A method for managing innovation, comprising the steps:
entering an innovation into a database;
providing a system for evaluating said innovation;
completing a business plan for implementing said innovation; and
mapping said innovation to specific customer pain points.

8. A method according to claim 7, wherein said customer pain points are built into said database.

9. A method according to claim 7, further comprising the steps:
identifying said specific customer pain points; and
display said innovation in response to one of said customer pain points being identified.

10. A method according to claim 7, wherein:
said step of providing said system includes the step of passing said innovation through a plurality of stages of development, each of said stages having a set of requirements for said innovation;
said stages are arranged in an order; and
the requirements for said stages become increasingly rigorous in said order.

11. A method according to claim 7, wherein said step of providing said system includes the steps of:
identifying a queue manager for managing said database; and
informing said queue manager when said innovation is entered into said database.

12. A method according to claim 11, wherein said step of providing said system includes the further steps of:
identifying a group of people to evaluate said innovation;
for each of said group of people, providing an evaluation of said innovation;
notifying said queue manger whenever one of said evaluations is provided; and
showing to said queue manager said evaluations from said group of people.

13. A program storage device readable by machine, tangibly embodying a program of instructions executable by the machine to perform method steps for managing innovation, the method steps comprising:
entering an innovation into a database;
providing a procedure for evaluating said innovation;
completing a business plan for implementing said innovation; and
mapping said innovation to specific customer pain points.

14. A program storage device according to claim 13, wherein said customer pain points are built into said database; and said method steps further comprise the steps of:
identifying said specific customer pain points; and
displaying said innovation in response to one of said customer pain points being identified.

15. A program storage device according to claim 13, wherein:
said step of providing said procedure includes the step of passing said innovation through a plurality of stages of development, each of said stages having a set of requirements for said innovation;
said stages are arranged in an order; and
the requirements for said stages become increasingly rigorous in said order.

16. A program storage device according to claim 13, wherein said step of providing said procedure includes the steps of:
identifying a queue manager for managing said database; and
informing said queue manager when said innovation is entered into said database.

17. A program storage device according to claim 16, wherein said step of providing said procedure includes the further steps of:
identifying a group of people to evaluate said innovation;
for each of said group of people, providing an evaluation of said innovation;
notifying said queue manger whenever one of said evaluations is provided; and
showing to said queue manager said evaluations from said group of people.

18. A method of deploying a computer program product for managing innovation, wherein when executed, the computer program performs the steps of:
entering an innovation into a database;
providing a procedure for evaluating said innovation;
completing a business plan for implementing said innovation; and
mapping said innovation to specific customer pain points.

19. A method according to claim 18, wherein said customer pain points are built into said database; and said method steps further comprise the steps of
identifying said specific customer pain points; and
displaying said innovation in response to one of said customer pain points being identified.

20. A method according to claim 18, wherein:
said step of providing said procedure includes the step of passing said innovation through a plurality of stages of development, each of said stages having a set of requirements for said innovation;
said stages are arranged in an order; and
the requirements for said stages become increasingly rigorous in said order.

21. A method according to claim 18, wherein said step of providing said procedure includes the steps of:
identifying a queue manager for managing said database; and
informing said queue manager when said innovation is entered into said database.

22. A method according to claim 21, wherein said step of providing said procedure includes the further steps of:
identifying a group of people to evaluate said innovation;
for each of said group of people, providing an evaluation of said innovation;
notifying said queue manger whenever one of said evaluations is provided; and
showing to said queue manager said evaluations from said group of people.
